(19) United States
(12) Patent Application Publication
(10) Pub. No.: US 2024/0001328 A1
(43) Pub. Date: Jan. 4, 2024

(54) SYSTEMS, METHODS, AND APPARATUSES FOR CONVERTING MATERIAL WITH MICROWAVE ENERGY

(71) Applicant: NUIONIC TECHNOLOGIES (CANADA) INC., New Brunswick (CA)

(72) Inventor: James M. TRANQUILLA, Fredericton (CA)

(21) Appl. No.: 18/254,100

(22) PCT Filed: Nov. 23, 2021
(86) PCT No.: PCT/CA2021/051663

§ 371 Date: May 23, 2023

Related U.S. Application Data
(60) Provisional application No. 63/117,342, filed on Nov. 23, 2020.

(51) Int. Cl. B01J 19/12; C01B 3/44

(52) U.S. Cl. CPC B01J 19/126; C01B 3/44; C01B 2203/0233; C01B 2203/0855; B01J 2219/1227; B01J 2219/1239; B01J 2219/1269; B01J 2219/0883; B01J 2219/0892; B01J 2219/1266; B01J 2219/1293

(57) ABSTRACT

There is provided an apparatus comprising a microwave generator, for heating catalyst material, and an electrochemical pump. A reactive process is catalyzed by the heated catalyst material to produce reaction products, and some of the reaction products are recovered via the electrochemical pump.

### FIELD

The present disclosure relates to microwave reactors.

### BACKGROUND

Large-scale hydrogen generation is most economically carried out through the use of large steam methane reforming (SMR) reactors, however smaller-scale applications cannot, in general, be satisfied in this manner. The fundamental limitation associated with most of the small-scale reactor designs to date is that the economics associated with the large-scale SMR process do not scale down favorably, due largely to heat management issues, and it is generally understood that any practical solution must incorporate a very high degree of heat management and system integration.

### SUMMARY

In one aspect, there is provided an apparatus comprising:
a microwave generator;
a microwave-stimulated conversion zone defined within the housing; and
a material converter disposed in flow communication with the microwave-stimulated conversion zone;
   wherein:
the microwave generator, the microwave-stimulated conversion zone, and the material converter are co-operatively configured such that, while catalyst material is disposed within the microwave-stimulated conversion zone and the microwave generator is generating microwave energy with effect that a microwave field is established within the microwave-stimulated conversion zone and dielectric heating of the catalyst material is effectuated such that a heated catalyst material is established, and while a first convertible material is being supplied to the microwave-stimulated conversion zone, the first convertible material is converted into a microwave-stimulated conversion product material, such that a second convertible material is emplaced in a conversion-effective relationship relative to the material converter;
wherein:
   the second convertible material is derived from the microwave-stimulated conversion product material; and
   the material converter is configured for converting the second convertible material while the second convertible material is emplaced in a conversion-effective relationship relative to the material converter, with effect that a material converter-converted product is produced and discharged from the apparatus.

In another aspect, there is provided an apparatus comprising:
a microwave generator;
a microwave conductor, coupled to the microwave generator, and defining a cavity; and
a microwave conductor shield spaced-apart from the conductor such that an intermediate space is defined between the conductor and the conductor shield; and
a material converter disposed within the cavity of the microwave conductor; wherein:
the microwave-stimulated conversion zone is defined within the intermediate space;
the material converter is disposed in flow communication with the microwave-stimulated conversion zone;
the microwave generator, the microwave conductor, the microwave conductor shield, and the material converter are co-operatively configured such that, while catalyst material is disposed within the microwave-stimulated conversion zone and the microwave generator is generating microwave energy with effect that a microwave field is established within the microwave-stimulated conversion zone and dielectric heating of the catalyst material is effectuated such that a heated catalyst material is established, and while a first convertible material is being supplied to the microwave-stimulated conversion zone, the first convertible material is converted into a microwave-stimulated conversion product material, such that a second convertible material is emplaced in a conversion-effective relationship relative to the material converter;
wherein:
   the second convertible material is derived from the microwave-stimulated conversion product material; and
   the material converter is configured for converting the second convertible material while the second convertible material is emplaced in a conversion-effective relationship relative to the material converter, with effect that a material converter-converted product is produced.

In another aspect, there is provided an apparatus comprising:
a microwave generator;
a porous microwave conductor, coupled to the microwave generator, and defining a cavity; and
a microwave conductor shield spaced-apart from the conductor such that an intermediate space is defined between the conductor and the conductor shield; and
a material converter;
   wherein:
the microwave-stimulated conversion zone is defined within the intermediate space;
the material converter is disposed in flow communication with the microwave-stimulated conversion zone via the porous microwave conductor;
the microwave generator, the microwave conductor, the microwave conductor shield, and the material converter are co-operatively configured such that, while catalyst material is disposed within the microwave-stimulated conversion zone and the microwave generator is generating microwave energy within the microwave-stimulated conversion zone with effect that a microwave field is established within the microwave-stimulated conversion zone and dielectric heating of the catalyst material is effectuated such that a heated catalyst material is established, and while a first convertible material is being supplied to the microwave-stimulated conversion zone, the first convertible material is converted into a microwave-stimulated conversion product material, such that a second convertible material is emplaced in a conversion-effective relationship relative to the material converter;
wherein:
   the second convertible material is derived from the microwave-stimulated conversion product material; and
   the material converter is configured for converting the second convertible material while the second convertible material is emplaced in a conversion-effective relationship relative to the material converter, with effect that a material converter-converted product is produced.

In another aspect, there is provided an apparatus comprising:
a microwave generator;
a microwave conductor, coupled to the microwave generator, and defining a cavity; and
a microwave conductor shield spaced-apart from the conductor such that an intermediate space is defined between the conductor and the conductor shield; and
a material converter;
   wherein:
the microwave-stimulated conversion zone is defined within the intermediate space;
the material converter is disposed in flow communication with the microwave-stimulated conversion zone;
   wherein:
the microwave generator, the microwave conductor, the microwave conductor shield, and the material converter are co-operatively configured such that, while catalyst material is disposed within the microwave-stimulated conversion zone and the microwave generator is generating microwave energy with effect that a microwave field is established within the microwave-stimulated conversion zone and dielectric heating of the catalyst material is effectuated such that a heated catalyst material is established, and while a first convertible material is being supplied to the microwave-stimulated conversion zone, the first convertible material is converted into a microwave-stimulated conversion product material, such that a second convertible material becomes emplaced in a conversion-effective relationship relative to the material converter;
wherein:
   the second convertible material is derived from the microwave-stimulated conversion product material;
   the material converter is configured for converting the second convertible material while the second convertible material is emplaced in a conversion-effective relationship relative to the material converter, with effect
that a material converter-converted product is produced; and
   the material converter is electromagnetically shielded from the generated microwave energy

In another aspect, there is provided a method of producing gaseous molecular hydrogen (H₂), comprising:

while a microwave field is established within a microwave-stimulated conversion zone, disposed in flow communication with a separator, such that catalyst material, disposed within the microwave-stimulated conversion zone, is heated, supplying a first convertible material, including methane (CH₄) and steam (H₂O) to the microwave-stimulated conversion zone, such that:
the first convertible material becomes disposed in a reaction catalyzing-effective proximity to the heated catalyst material, with effect that a reactive process is catalyzed by the heated catalyst material, with effect that a microwave-stimulated conversion product material is produced, wherein the microwave-stimulated conversion product material includes gaseous molecular hydrogen (H₂) and gaseous carbon monoxide (CO); and
the microwave-stimulated conversion product becomes emplaced in a conversion-effective relationship relative to the separator, such that a product material is separated from the microwave-stimulated conversion product, wherein the product material includes the gaseous molecular hydrogen.

### BRIEF DESCRIPTION OF DRAWINGS

The embodiments will now be described with reference to the following accompanying drawings, in which:

FIG. 1 is a schematic illustration of an embodiment of an apparatus of the present disclosure; and

FIG. 2 is a schematic illustration of another embodiment of an apparatus of the present disclosure.

### DETAILED DESCRIPTION

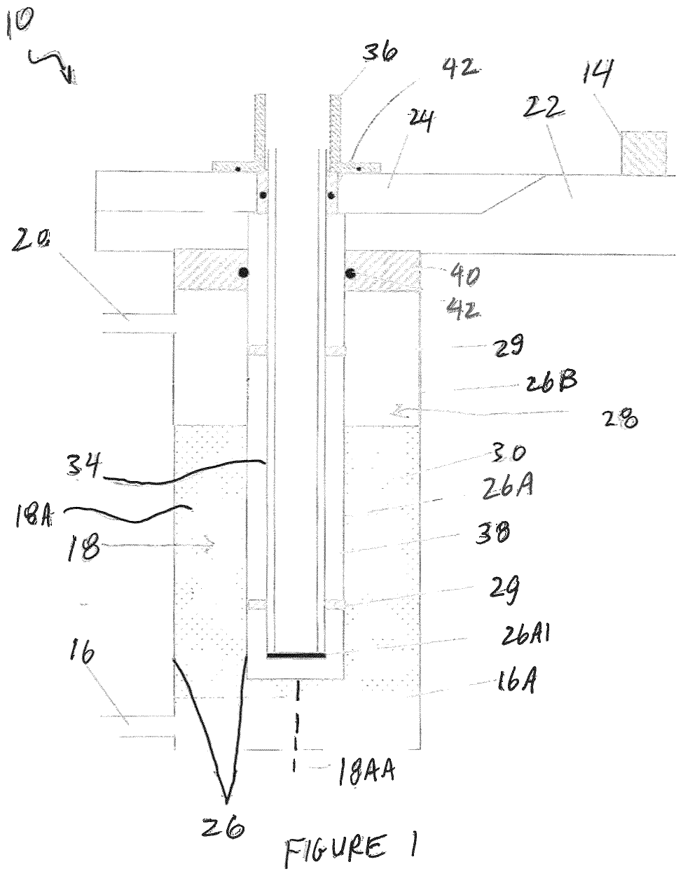

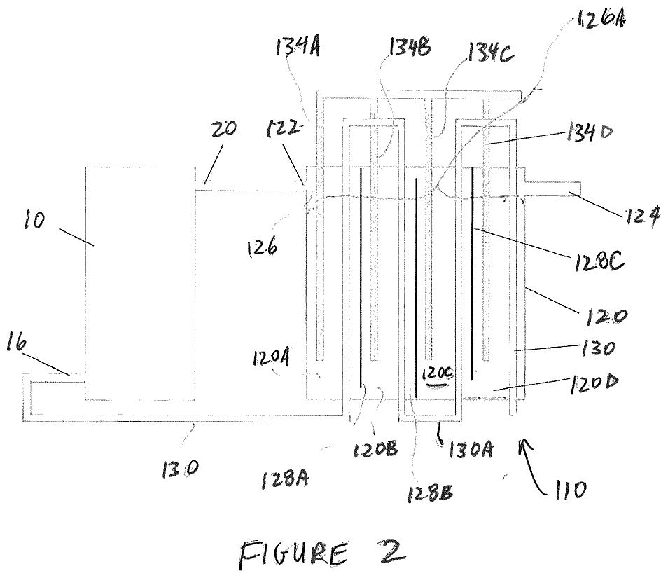

Referring to FIGS. 1 and 2, there is provided an apparatus 10 for converting a first convertible material (e.g. a gaseous mixture), to a microwave-stimulated conversion product material, wherein the conversion is stimulated by microwave energy. A second convertible material (e.g. another gaseous mixture), deriving from the first convertible material, is converted by a material converter 34.

In this respect, the apparatus 10 includes a microwave generator 14 (such as, for example, a magnetron) for generating microwave energy. In some embodiments, the generated microwave energy may fall only within one or more industrial, scientific and medical (ISM) frequencies, such as, for example, about 915 MHz, or about 2450 MHz.

The apparatus 10 further defines a microwave-stimulated conversion zone 18, and co-operates with the microwave generator 14 with effect that the microwave-stimulated conversion zone is disposed for receiving the first convertible material, for stimulating conversion of the first convertible material by the generated microwave energy.

In some embodiments, for example, for effecting the transmission of microwave energy from the microwave generator 14 to the microwave-stimulated conversion zone 18, the apparatus further includes a waveguide 22, a microwave transformer 24, and an electrode configuration, such as, for example, a co-axial transmission line 26. The waveguide 22 is coupled to the microwave generator 14 for transmitting a microwave generated by the microwave generator 14 in the waveguide TE₁₀ mode. The microwave transformer 24 is configured for converting the waveguide TE₁₀ mode to the TEM mode. The co-axial transmission line 26 is coupled to the waveguide 22 via the microwave transformer 24. The co-axial transmission line 26 is defined by an inner microwave conductor 26A, coupled to the microwave transformer 24, and an outer microwave conductor shield 26B. The microwave conductor 26A and the microwave conductor 26B are disposed in a spaced apart relationship such that an intermediate space 28 is defined. Communication is effected at an interface between the waveguide 22 and the intermediate space 28 via a dielectric material 40. One or more sealing members 42 (e.g. o-ring seals) effect sealing of the space 28 from the waveguide 22. The microwave-stimulated conversion zone 18 is defined within the intermediate space 28.

In some embodiments, for example, the apparatus 10 is configured such that there is established a voltage minimum at the tip 26A1 of the microwave conductor 26A to mitigate versus accidental arcing. The material of construction of the microwave conductor 26A includes a suitably highly conductive metallic material which exhibits very low electrical loss at microwave frequencies and is thermally and chemically stable in the reactor environment.

In some embodiments, for example, the material of construction of the microwave conductor shield 26B is rated for strength at the temperature and pressure of operation. Typical materials would be alloys of steel, including alloys which are known to be resistant to embrittlement and carbon dusting under highly reducing atmospheres (such as hydrogen and methane).

In some embodiments, for example, the microwave generator 14, the waveguide 22, the microwave transformer 24, and the co-axial transmission line 26 are configurable in a microwave stimulation-effective configuration. In the microwave stimulation-effective configuration, the microwave generator 14 is generating microwave energy (and the generated microwave energy is communicated to the microwave transformer 24 via the waveguide 22, and the microwave transformer 24 induces flow of electric current within the microwave conductor 26A) with effect that a microwave field is established within the microwave-stimulated conversion zone 18.

While the microwave generator 14, the co-axial transmission line 26, and the microwave-stimulated conversion zone 18 are disposed in the microwave stimulation-effective configuration, and catalyst material is disposed within the microwave-stimulated conversion zone 18, dielectric heating of the catalyst material is effected such that the catalyst material is heated. In some embodiments, for example, the catalyst material includes metallic material.

While the dielectric heating of the catalyst material is being effected such that the catalyst material is heated, and a first convertible material is disposed in a reaction catalyzing-effective proximity to the heated catalyst material, a reactive process is effected and is catalyzed by the heated catalyst material, with effect that a microwave-stimulated conversion product material is produced.

In some embodiments, for example, the first convertible material includes methane (CH₄) and steam (H₂O), and the conversion includes steam reformation, such that the microwave-stimulated conversion product material includes gaseous molecular hydrogen (H₂) and gaseous carbon monoxide (CO). In some of these embodiments, for example, the microwave-stimulated conversion product material further includes gaseous carbon dioxide (CO₂).

In some embodiments, for example, the catalyst material is defined on at least the surface of particulate material which is disposed within the microwave-stimulated conversion zone 18. In some embodiments, for example, the catalytic material is a nickel metallized carrier particle which is selective in the decomposition of the convertible gas into gaseous molecular hydrogen. In some embodiments, for example, the particulate material defines a bed of particulate material, and the catalyzed reactive process is effected while the bed is fluidized by flow of the first convertible material, such that a fluidized bed 30 is obtained.

As described above, the apparatus 10 further includes the material converter 34. The material converter 34 is disposed in flow communication with the microwave-stimulated conversion zone 18. In this respect, in some embodiments, for example, the microwave generator 14, the waveguide 22, the microwave transformer 24, the co-axial transmission line 26, and the material converter 34 are co-operatively configured such that, while the first convertible material is being supplied to the microwave-stimulated conversion zone 18, and the microwave generator 14, the waveguide, and the co-axial transmission line 26, are disposed in the microwave stimulation-effective configuration, and catalyst material is disposed within the microwave-stimulated conversion zone 18 such that a heated catalyst material is established, conversion of the first convertible material is stimulated within the microwave-stimulated conversion zone 18 such that a microwave-stimulated conversion product material is obtained, and such that a second convertible material becomes emplaced in a conversion-effective relationship relative to the material converter 34. The emplacement of the second convertible material in a conversion-effective relationship relative to the material converter 34 is effectuated by the flow communication between the microwave-stimulated conversion zone 18 and the material converter 34.

The second convertible material derives from the microwave-stimulated conversion product. In this respect, the second convertible material includes the microwave-stimulated conversion product material, a derivative material deriving from the microwave-stimulated conversion product material, or a portion of the microwave-stimulated conversion product material and derivative material deriving from the microwave-stimulated conversion product material.

The material converter 34 is configured for, while the second convertible material is emplaced in a conversion-effective relationship relative to the material converter 34, converting the second convertible material, such that a material converter-converted product is produced and discharged from the apparatus. In this respect, the material converter 34 includes a flow discharging communicator 36 (such as, for example, a port) for discharging, and thereby recovering, the material converter-converted product.

In some embodiments, for example, the converting includes a separation. In some embodiments, for example, the converting includes a fractionation.

In some embodiments, for example, the second convertible material includes a target material, and the converting, for which the material converter 34 is configured, is with effect that at least a portion of the target material is separated from the second convertible material such that the discharged material converter-converted product includes the target material. In some of these embodiments, for example, the converting, for which the material converter 34 is configured, includes a fractionation of the second convertible material, such that a target material-rich product is separated from a target material-depleted product and the discharged material converter-converted product includes the target material. In some embodiments, for example, the target material includes gaseous molecular hydrogen.

In some embodiments, for example, the material converter 34 includes a membrane, such that the converting includes a fractionation into a permeate and a retentate, wherein the discharged material converter-converted product is defined by the permeate, such that the permeate includes the target material.

In some of these embodiments, for example, the material converter 34 includes an ion transport membrane. In some of these embodiments, for example, the material converter 34 includes an electrochemical pump. In some of these embodiments, for example, where the target material includes gaseous molecular hydrogen, and the material converter 34 includes an electrochemical pump, the ion transport membrane includes a proton exchange membrane (connected to a DC power supply for energizing the proton exchange membrane), and the conversion of the second convertible material is with effect that pressurized gaseous molecular hydrogen is produced and discharged via the flow discharging communicator 36. In some embodiments, for example, the pressurized gaseous molecular hydrogen is recovered via the flow discharging communicator 36. In some embodiments, for example, the discharged pressurized gaseous molecular hydrogen is disposed at a pressure of at least 25 bar, such as, for example, 50 bar. In some embodiments, for example, the pressurized gaseous molecular hydrogen is conducted to a compressor for pressurization with effect that the gaseous molecular hydrogen becomes further pressurized.

In some embodiments, for example, the proton exchange membrane consists of a BaZrCeYO (“BCZY”) electrolyte sandwiched between two BCZY-Ni porous electrodes and connected to a DC voltage source for the purpose of enacting proton transfer through the membrane. In operation, the second convertible gaseous material (including gaseous molecular hydrogen) is in contact with the cathode (negative) side of the electrolyte and pressurized, gaseous molecular hydrogen is produced at the anode (positive) side. In some embodiments, for example, the area specific resistance of the electrolyte is <0.4 Ohm cm². In some of these embodiments, for example, the cathode is in contact with the second convertible material and the gaseous molecular hydrogen produced at the anode is of high purity. In some embodiments, for example, the produced hydrogen purity is >90%.

In operation, while the first convertible material is being supplied to the microwave-stimulated conversion zone 18 and the microwave generator 14 is generating microwave energy (e.g. while the microwave generator 14, the waveguide 22, the microwave transformer 24, the co-axial transmission line 26, and the intermediate space 28 are disposed in the microwave stimulation-effective configuration), and catalyst material is disposed within the microwave-stimulated conversion zone 18, such that a heated catalyst material is established, conversion of the first convertible material is effectuated within the microwave-stimulated conversion zone 18 such that the microwave-stimulated conversion product material is obtained, and the second convertible material becomes emplaced in a conversion-effective relationship relative to the material converter 34. In response to emplacement of the second convertible material in a conversion-effective relationship relative to the material converter 34, the conversion of the second convertible material is effected. In some embodiments, for example, the conversion of the first convertible material within the microwave-stimulated conversion zone 18, and the conversion of the second convertible material by the material converter 34 is continuous.

In some embodiments, for example, the discharging of the produced material converter-converted product, from the apparatus 10, is with effect that accumulation of target material, in a conversion-effective relationship relative to the material converter 34, is mitigated, such that an equilibrium shift is effected towards conversion of the first convertible material within the microwave-stimulated conversion zone 18.

In some embodiments, for example, the microwave-stimulated conversion zone 18 includes a relatively large cross-sectional flow area-defined portion 18A. The relatively large cross-sectional flow area-defined portion 18A defines a minimum cross-sectional flow area of at least 37 square centimeters, such as, for example, at least 300 square centimeters, such as, for example, at least 750 square centimeters. In some embodiments, for example, the relatively large cross-sectional flow area-defined portion 18A has a length of at least 25 centimeters measured along a central longitudinal axis 18AA of the relatively large cross-sectional flow area-defined portion. In some embodiments, for example, the length is at least 61 centimeters measured along a central longitudinal axis of the relatively large cross-sectional flow area-defined portion. In some embodiments, for example, the length is at least 122 centimeters measured along a central longitudinal axis of the relatively large cross-sectional flow area-defined portion.

In some embodiments, for example, the apparatus 10 includes a housing 12, and both of the conversion of the first convertible material and the conversion of the second convertible material is effected within the housing 12. In this respect, the microwave-stimulated conversion zone 18 is defined within the housing 12, and the material converter 34 is disposed within the housing 12. In some embodiments, for example, the microwave conductor shield 26B is defined by a portion of the housing 12.

In some embodiments, for example, the housing 12 defines a flow receiving communicator 16, the microwave-stimulated conversion zone 18, and a flow discharging communicator 20. In some embodiments, for example, the flow receiving communicator 16 is disposed in flow communication with the flow discharging communicator 20 via the microwave-stimulated conversion zone 18. In some embodiments, for example, the flow receiving communicator 16 is in the form of a port. In some embodiments, for example, the flow discharging communicator 20 is in the form of a port.

In some embodiments, for example, the flow receiving communicator 16, the microwave generator 14, the waveguide 22, the microwave transformer 24, and the co-axial transmission line 26 are co-operatively configured such that, while the microwave generator 14, the waveguide 22, the microwave transformer 24, and the co-axial transmission line 26 are disposed in the microwave stimulation-effective configuration, and catalyst material is disposed within the microwave-stimulated conversion zone 18 such that a heated catalyst material is established, and while feed material is being received by the flow receiving communicator 16 such that a first convertible material, derived from the feed material, is disposed within the microwave-stimulated conversion zone 18, conversion of the first convertible material is stimulated within the microwave-stimulated conversion zone 18 such that the microwave-stimulated conversion product material is obtained.

As described above, the first convertible material derives from the feed material. In this respect, the first convertible material includes the feed material, derivative material deriving from the feed material, or a portion of the feed material and derivative material deriving from the feed material.

In some embodiments, for example, the catalyst material is defined on at least the surface of particulate material which is disposed within the microwave-stimulated conversion zone 18 (such that particulate catalyst material is defined), and the particulate catalyst material defines a bed of particulate catalyst material that is fluidized by flow of the first convertible material, in some of these embodiments, for example, the flow of the first conductible material through the microwave-stimulated conversion zone 18 is established while a flow of material, from the flow receiving communicator 16 to the flow discharging communicator 20, is established. In this respect, in some embodiments, the flow receiving communicator 16 is disposed in flow communication with the flow discharging communicator 20 via a fluid passage 32 extending from the flow receiving communicator 16 to the flow discharging communicator 20. In this respect, the fluid passage 32 extends through the intermediate space 28.

In some embodiments, for example, a screen 16A is integrated within the flow receiving communicator 16 for preventing egress of the particulate catalyst material from the microwave-stimulated conversion zone 18 via the flow receiving communicator 16. Similarly, in some embodiments, for example, a filtration device, such as, for example, a cyclone filter, is integrated within the flow discharging communicator 20 for separating and recovering any particulate catalyst material which becomes entrained within gaseous material that is being discharged via the flow discharging communicator 20.

In those embodiments where the discharging of the produced material converter-converted product, from the apparatus 10, is with effect that the accumulation of the microwave-stimulated conversion product material, within the microwave-stimulated conversion zone 18, is mitigated, such that an equilibrium shift is effected towards conversion of the first convertible material within the microwave-stimulated conversion zone 18, in some of these embodiments, for example, the conductor 26A defines a cavity 38, and the material converter 34 is disposed within the cavity 38. In some embodiments, for example, the material converter 34 is mounted to the conductor 26A, within the cavity 38, with insulating supports 29. In this respect, in order for fluid communication to be established between the material converter 34 and the microwave-stimulated conversion zone 18 (so that emplacement of the second convertible material, in a conversion-effective relationship relative to the material converter 34, can be established), the conductor 26A is porous (defines a plurality of apertures), sufficient for establishing the flow communication between the material converter 34 and the microwave-stimulated conversion zone 18. In some embodiments, for example, the porosity of the conductor 26A is sufficient for establishing the flow communication between the material converter 34 and the microwave-stimulated conversion zone 18 such that the emplacement of the second convertible material, in a conversion-effective relationship relative to the material converter 34, is establishable, but is insufficient for effecting at least a non-negligible transport of the particulate catalyst material of the fluidized bed 30 from the microwave-stimulated conversion zone 18 to the material converter 34. In some embodiments, for example, the conductor 26A prevents the transport of the particulate catalyst material of the fluidized bed 30 from the microwave-stimulated conversion zone 18 to the material converter 34. In those embodiments where the material converter 34 includes an electrochemical pump, in some of these embodiments, for example, the conductor 26A functions to shield and electrically isolate the cavity 38 from the microwave field that is establishable within the intermediate space 28, such that interference with operation of the electrochemical pump, by the microwave field, is prevented.

In some embodiments, for example, the material converter 34 is disposed laterally relative to the microwave-stimulated conversion zone 18.

In those embodiments where the material converter 34 includes an electrochemical pump, while the separation is being effected, heat is generated, and the material converter 34 is disposed in sufficient proximity to the microwave-stimulated conversion zone 18 such that the generated heat is transferred to the first convertible material within the microwave-stimulated conversion zone 18, with effect that the conversion of the first convertible material is further stimulated.

In operation, the feed material is received by the flow receiving communicator 14, with effect that the first convertible material becomes emplaced within the microwave-stimulated conversion zone 18. While the microwave generator 14 is generating microwave energy (e.g. while the microwave generator 14, the waveguide 22, the microwave transformer 24, and the co-axial transmission line 26, are disposed in the microwave stimulation-effective configuration), and the catalyst material is disposed within the microwave-stimulated conversion zone 18 such that a heated catalyst material is established, the first convertible material is converted such that the microwave-stimulated conversion product material is obtained, and the second convertible material becomes emplaced in a conversion-effective relationship relative to the material converter 34. In response to emplacement of the second convertible material in a conversion-effective relationship relative to the material converter 34, the conversion of the second convertible material is effected, and the conversion of the second convertible material is with effect that the accumulation of the microwave-stimulated conversion product material, within the microwave-stimulated conversion zone 18, is mitigated, such that an equilibrium shift is effected towards conversion of the first convertible material within the microwave-stimulated conversion zone 18. In this respect, the conversion of the first convertible material and the conversion of the second convertible material co-operate with effect that a target material-comprising product is discharged from the apparatus via the flow discharging communicator 36 and a residual target material-comprising product is discharged from the apparatus via the flow discharging communicator 20.

In some embodiments, for example the receiving of the feed material by the flow receiving communicator 16, the conversion of the first convertible material within the microwave-stimulated conversion zone 18, the conversion of the second convertible material by the material converter 34, and the discharging of the product material is continuous.

Referring to FIG. 2, in some embodiments, for example, where there is sufficient target material present in the residual target material-comprising product being discharged via the flow discharging communicator 20, the residual target material-comprising product is conducted to a second apparatus 110 for recovering of target material from the residual target material-comprising product via a material converter 134.

In some embodiments, for example, the second apparatus defines a flow receiving communicator 122 (e.g. a port) and a flow discharging communicator 124 (e.g. a port). Additionally, the second apparatus includes the material fluid conductor 134. The flow receiving communicator 122 is disposed in fluid communication with the flow discharging communicator 124 via the material fluid conductor 126.

The flow receiving communicator 122 is configured for receiving the residual target material-comprising product being discharged from the first apparatus 10. The material converter 34 is disposed in fluid communication with the material fluid conductor 126. In response to the receiving of the residual target material-comprising product by the flow receiving communicator 122, a convertible material, derived from the received residual target material-comprising product, and including the target material, becomes emplaced within the material fluid conductor 126 in a conversion-effective relationship relative to the material converter 134, with effect that the convertible material is converted with effect that a target material-comprising product is produced and discharged from the apparatus 110. In some embodiments, for example, the material converter 134 includes an electrochemical pump, such that heat energy is generated in response to operation of the electrochemical pump.

In some embodiments, for example, the material converter 134 is also disposed in heat transfer communication with the material fluid conductor 126, such that the generated heat energy is communicable to the fluid material within the material fluid conductor 126. In some of these embodiments, for example, this heat transfer communication is an indirect heat transfer communication.

In some embodiments, for example, a feed material-conducting fluid conductor 130 is disposed in fluid communication with the flow receiving communicator 16 of the first apparatus 10 for supplying the feed material to the first apparatus 10. In some embodiments, for example, the material fluid conductor 126 is disposed in heat transfer communication with the feed material-conducting fluid conductor 130. In some of these embodiments, for example, this heat transfer communication is an indirect heat transfer communication. In this respect, in some embodiments, for example, the material converter 134 is disposed in indirect heat transfer communication with the feed material-conducting fluid conductor 130.

The material fluid conductor 126, the material converter 134, and the feed material-conducting fluid conductor 130 are co-operatively configured such that, while: (i) the convertible material is emplaced within the material fluid conductor 126 in a conversion-effective relationship relative to the material converter 134, such that the conversion of the convertible material is being effectuated by the material converter 134, and (ii) the feed material is being supplied to the flow receiving communicator 16 of the first apparatus 10 via the feed material-conducting fluid conductor 130, the heat energy, generated in response to the conversion of the convertible material, is communicated to the feed material, prior to the supplying of the feed material to the flow receiving communicator 16 of the first apparatus 10.

In some embodiments, for example, the second apparatus 110 includes a second housing, and the second housing 120 defines a plurality of interconnected spaces 120A-D, separated from each other by baffles 128A-C. The material converter 134 include material converter portions 134A-D, and each one of the portions 134A-D, independently, is disposed within a respective one of the spaces 120A-D. The feed material-conducting fluid conductor 130 extends through the spaces 120A-D, with effect that a tortuous fluid passage portion 130A is defined by the feed material-conducting fluid conductor 130. The interconnected spaces 120A-D, the material converter 134, and the feed material-conducting conductor 130 are co-operatively configured such that a tortuous path-defining portion 126A of the material fluid conductor 126 is defined within the interconnected spaces, and with effect that the heat energy, generated in response to the conversion of the convertible material, is communicated to the feed material within the feed material-conducting conductor 130, via the fluid material being conducted via the tortuous path-defining portion 126A of the material fluid conductor 126, such that a heated feed material is obtained, prior to the supplying of the feed material to the flow receiving communicator 112 of the first housing 110.

In the above description, for purposes of explanation, numerous details are set forth in order to provide a thorough understanding of the present disclosure. However, it will be apparent to one skilled in the art that these specific details are not required in order to practice the present disclosure. Although certain dimensions and materials are described for implementing the disclosed example embodiments, other suitable dimensions and/or materials may be used within the scope of this disclosure. All such modifications and variations, including all suitable current and future changes in technology, are believed to be within the sphere and scope of the present disclosure. All references mentioned are hereby incorporated by reference in their entirety.

1.-52. (canceled)

53. An apparatus comprising:
a microwave generator;
a microwave-stimulated conversion zone defined within the housing; and
a material converter disposed in flow communication with the microwave-stimulated conversion zone;
wherein:
the microwave generator, the microwave-stimulated conversion zone, and the material converter are co-operatively configured such that, while catalyst material is disposed within the microwave-stimulated conversion zone and the microwave generator is generating microwave energy with effect that a microwave field is established within the microwave-stimulated conversion zone and dielectric heating of the catalyst material is effectuated such that a heated catalyst material is established, and while a first convertible material is being supplied to the microwave-stimulated conversion zone, the first convertible material is converted into a microwave-stimulated conversion product material, such that a second convertible material is emplaced in a conversion-effective relationship relative to the material converter;
wherein:
the second convertible material is derived from the microwave-stimulated conversion product material; and
the material converter is configured for converting the second convertible material while the second convertible material is emplaced in a conversion-effective relationship relative to the material converter, with effect that a material converter-converted product is produced and discharged from the apparatus.

54. The apparatus as claimed in claim 53;
wherein:
the converting, for which the material converter is configured, includes a fractionation of the second convertible material, wherein the fractionation is with effect that a target material-rich product is separated from a target material-depleted product, such that the discharged material converter-converted product includes the separated target material.

55. The apparatus as claimed in claim 54;
wherein:
the material converter includes a membrane.

56. The apparatus as claimed in claim 55;
wherein:
the material converter includes an electrochemical pump.

57. The apparatus as claimed in claim 53;
wherein:
the conversion of the second convertible material is with effect that the accumulation of the microwave-stimulated conversion product material, within the microwave-stimulated conversion zone, is mitigated, such that an equilibrium shift is effected towards conversion of the first convertible material within the microwave-stimulated conversion zone.

58. The apparatus as claimed in claim 53;
wherein:
the microwave-stimulated conversion zone includes a relatively large cross-sectional flow area-defined portion;
the relatively large cross-sectional flow area-defined portion defines a minimum cross-sectional flow area of at least 37 square centimeters.

59. The apparatus as claimed in claim 58;
wherein:
the relatively large cross-sectional flow area-defined portion has a length of at least 25 centimeters measured along a central longitudinal axis of the relatively large cross-sectional flow area-defined portion.

60. An apparatus comprising:
a microwave generator;
a microwave conductor, coupled to the microwave generator, and defining a cavity; and
a microwave conductor shield spaced-apart from the conductor such that an intermediate space is defined between the conductor and the conductor shield; and
a material converter disposed within the cavity of the microwave conductor;
wherein:
the microwave-stimulated conversion zone is defined within the intermediate space;
the material converter is disposed in flow communication with the microwave-stimulated conversion zone;
the microwave generator, the microwave conductor, the microwave conductor shield, and the material converter are co-operatively configured such that, while catalyst material is disposed within the microwave-stimulated conversion zone and the microwave generator is generating microwave energy with effect that a microwave field is established within the microwave-stimulated conversion zone and dielectric heating of the catalyst material is effectuated such that a heated catalyst material is established, and while a first convertible material is being supplied to the microwave-stimulated conversion zone, the first convertible material is converted into a microwave-stimulated conversion product material, such that a second convertible material is emplaced in a conversion-effective relationship relative to the material converter;
wherein:
the second convertible material is derived from the microwave-stimulated conversion product material; and
the material converter is configured for converting the second convertible material while the second convertible material is emplaced in a conversion-effective relationship relative to the material converter, with effect that a material converter-converted product is produced.

61. The apparatus as claimed in claim 60;
wherein:
the material converter includes a flow discharging communicator;
the converting, for which the material converter is configured, includes a fractionation of the second convertible material, wherein the fractionation is with effect that a target material-rich product is separated from a target material-depleted product; and
the separated target material is discharged via the flow discharging communicator.

62. The apparatus as claimed in claim 61;
wherein:
the material converter includes a membrane.

63. An apparatus comprising:
a microwave generator;
a porous microwave conductor, coupled to the microwave generator, and defining a cavity; and
a microwave conductor shield spaced-apart from the conductor such that an intermediate space is defined between the conductor and the conductor shield; and
a material converter;
wherein:
the microwave-stimulated conversion zone is defined within the intermediate space;
the material converter is disposed in flow communication with the microwave-stimulated conversion zone via the porous microwave conductor;
the microwave generator, the microwave conductor, the microwave conductor shield, and the material converter are co-operatively configured such that, while catalyst material is disposed within the microwave-stimulated conversion zone and the microwave generator is generating microwave energy within the microwave-stimulated conversion zone with effect that a microwave field is established within the microwave-stimulated conversion zone and dielectric heating of the catalyst material is effectuated such that a heated catalyst material is established, and while a first convertible material is being supplied to the microwave-stimulated conversion zone, the first convertible material is converted into a microwave-stimulated conversion product material, such that a second convertible material is emplaced in a conversion-effective relationship relative to the material converter;
wherein:
the second convertible material is derived from the microwave-stimulated conversion product material; and
the material converter is configured for converting the second convertible material while the second convertible material is emplaced in a conversion-effective relationship relative to the material converter, with effect that a material converter-converted product is produced.

64. The apparatus as claimed in claim 63;
wherein:
the material converter includes a flow discharging communicator;
the converting, for which the material converter is configured, includes a fractionation of the second convertible material, wherein the fractionation is with effect that a target material-rich product is separated from a target material-depleted product; and
the separated target material is discharged via the flow discharging communicator.

65. The apparatus as claimed in claim 64;
wherein:
the material converter includes a membrane.

66. An apparatus comprising:
a microwave generator;
a microwave conductor, coupled to the microwave generator, and defining a cavity; and
a microwave conductor shield spaced-apart from the conductor such that an intermediate space is defined between the conductor and the conductor shield; and
a material converter;
wherein:
the microwave-stimulated conversion zone is defined within the intermediate space;
the material converter is disposed in flow communication with the microwave-stimulated conversion zone;
wherein:
the microwave generator, the microwave conductor, the microwave conductor shield, and the material converter are co-operatively configured such that, while catalyst material is disposed within the microwave-stimulated conversion zone and the microwave generator is generating microwave energy with effect that a microwave field is established within the microwave-stimulated conversion zone and dielectric heating of the catalyst material is effectuated such that a heated catalyst material is established, and while a first convertible material is being supplied to the microwave-stimulated conversion zone, the first convertible material is converted into a microwave-stimulated conversion product material, such that a second convertible material becomes emplaced in a conversion-effective relationship relative to the material converter;
wherein:
the second convertible material is derived from the microwave-stimulated conversion product material;
the material converter is configured for converting the second convertible material while the second convertible material is emplaced in a conversion-effective relationship relative to the material converter, with effect that a material converter-converted product is produced; and
the material converter is electromagnetically shielded from the generated microwave energy.

67. The apparatus as claimed in claim 66;
wherein:
the converting, for which the material converter is configured, is effectuated by an electrically driven process.

68. The apparatus as claimed in claim 66;
wherein:
the material converter includes an electrochemical pump.

69. The apparatus as claimed in claim 66;
wherein:
the material converter includes a flow discharging communicator;
the converting, for which the material converter is configured, includes a fractionation of the second convertible material, wherein the fractionation is with effect that a target material-rich product is separated from a target material-depleted product; and
the separated target material is discharged via the flow discharging communicator.

70. A method of producing gaseous molecular hydrogen (H₂), comprising:
while a microwave field is established within a microwave-stimulated conversion zone, disposed in flow communication with a separator, such that catalyst material, disposed within the microwave-stimulated conversion zone, is heated, supplying a first convertible material, including methane (CH₄) and steam (H₂O) to the microwave-stimulated conversion zone, such that:
the first convertible material becomes disposed in a reaction catalyzing-effective proximity to the heated catalyst material, with effect that a reactive process is catalyzed by the heated catalyst material, with effect that a microwave-stimulated conversion product material is produced, wherein the microwave-stimulated conversion product material includes gaseous molecular hydrogen (H₂) and gaseous carbon monoxide (CO); and
the microwave-stimulated conversion product becomes emplaced in a conversion-effective relationship relative to the separator, such that a product material is separated from the microwave-stimulated conversion product, wherein the product material includes the gaseous molecular hydrogen.

71. The method as claimed in claim 70;
wherein:
the material converter includes an ion-conducting membrane.

72. The method as claimed in claim 71;
wherein:
the material converter includes an electrochemical pump.
